(19) United States
(12) Patent Application Publication
(10) Pub. No.: US 2019/0171648 A1
(43) Pub. Date: Jun. 6, 2019

(54) SYSTEM AND METHOD FOR IMPLEMENTING AN EXTRACT TRANSFORM AND LOAD (ETL) MIGRATION TOOL

(71) Applicant: JPMorgan Chase Bank, N.A., New York, NY (US)

(72) Inventors: Jagmohan SINGH, Coppell, TX (US); Ravikanth H. CUTTAMBAKAM, Flower Mound, TX (US)

(21) Appl. No.: 16/207,406

(22) Filed: Dec. 3, 2018

Related U.S. Application Data
(60) Provisional application No. 62/593,346, filed on Dec. 1, 2017.

(51) Int. Cl. G06F 16/25

(52) U.S. Cl. CPC G06F 16/254; G06F 16/258

(57) ABSTRACT

An embodiment of the present invention is directed to creating an automated system that reads a source data structure (in DML) and creates a target data structure (in XML). An embodiment of the present invention provides automated conversion of data structure metadata from a source data structure to a target data structure. The features of the various embodiments of the present invention may apply to any automated conversion system.

### CROSS REFERENCE TO RELATED APPLICATIONS

This application claims priority to U.S. Provisional Application 62/593,346 (Attorney Docket No. 72167.001341), filed Dec. 1, 2017, the contents of which are incorporated herein in its entirety.

### FIELD OF THE INVENTION

The invention relates generally to a system and method for implementing an extract transform and load (ETL) migration tool and more specifically to automated conversion of data structures from a source application to a target application.

### BACKGROUND OF THE INVENTION

With advances in technology, companies are in the progress of migrating data from legacy platforms to new technology solutions. For example, migration may be from a legacy ETL tool in a data environment to an open source ETL tool to be deployed in a data environment. Larger entities have an enormous amount of data that needs to be migrated. For example, some companies may have over 250,000 data structures currently defined in a legacy tool in a data environment. These data structures may include staging, work, intermediate, and semantic structures. With current tools, it will take an enormous amount of hours to manually convert these into target system data structures.

These and other drawbacks exist.

### SUMMARY OF THE INVENTION

According to one embodiment, the invention relates to a system that implements an extract, transform and load migration tool. A system implements extract, transform and load migration from a source data structure in a first language to a target data structure in a second language. The system comprises: a memory component that stores data relating to the source data structure and the target data structure; and a computer server coupled to the memory, the computer server comprising a programmed computer processor configured to perform the steps of: storing source data structure files in a first programming language in a designated folder; executing a conversion job from a source data structure to target data structure on a file by file basis; automatically converting files from the source data structure to the target data structure in a second programming language; storing the converted files in the same designated folder; and importing a target data structure schema.

According to one embodiment, the invention relates to a method that implements extract, transform and load migration from a source data structure in a first language to a target data structure in a second language. The method comprising the steps of: storing source data structure files in a first programming language in a designated folder; executing a conversion job from a source data structure to target data structure on a file by file basis; automatically converting files from the source data structure to the target data structure in a second programming language; storing the converted files in the same designated folder; and importing a target data structure schema.

The system may include a specially programmed computer system comprising one or more computer processors, interactive interfaces, electronic storage devices, and networks.

The computer implemented system, method and medium described herein provide unique advantages to entities, organizations and other users, according to various embodiments of the invention. The innovative system significantly reduces the amount of effort required for converting data structures. The features of the various embodiments of the present invention may apply to any automated conversion system. As more and more Enterprises move from closed/legacy to open source/big data solutions, any vendor providing ETL tool conversion solutions to Enterprises benefits from this solution. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary diagram of a standard ETL workflow.

FIG. 2 is an exemplary diagram of a ETL workflow, according to an embodiment of the present invention.

FIG. 3 is an exemplary flow diagram, according to an embodiment of the present invention.

FIG. 4 is an exemplary screenshot, according to an embodiment of the present invention.

FIGS. 5, 6 and 7 are an exemplary screenshots, according to an embodiment of the present invention.

FIG. 8 is an exemplary screenshot, according to an embodiment of the present invention.

FIGS. 9, 10 and 11 are an exemplary screenshots, according to an embodiment of the present invention.

FIG. 12 illustrates exemplary detailed code samples, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to creating an automated system that reads a source data structure and creates a target data structure. According to an exemplary illustration, the innovative system may read a source data structure in data manipulation language (DML) and create a target data structure in eXtensible markup language (XML). DML may represent a computer programming language that may be used for adding, inserting, deleting and modifying data in a database. XML may represent a markup language that defines a set of rules for encoding documents in a format that is human readable and machine readable. Conversions to and from other data structures in other data languages may be implemented and realized by the various embodiments of the present invention. DML and XML are merely exemplary. The innovative system significantly reduces the amount of effort required for converting data structures, in some instances. For example, the reduction of time may be from 1 million hours to a significantly reduced number of hours, e.g., substantially less than 1%. An embodiment of the present invention provides automated conversion of data structure metadata from a source data structure (e.g., Abinitio) to a target data structure (e.g., Talend). Abinitio represents a software that performs high-volume data processing applications used to extract, transform and load (ETL) data. Talend represents data integration software. The features of the various embodiments of the present invention may apply to any automated conversion system. As more and more Enterprises move from closed/legacy to open source/big data solutions, any entity (e.g., vendor, provider, etc.) providing ETL tool conversion solutions to Enterprises and other entities may benefit from this solution. An embodiment of the present invention may be implemented using the Python language. Other programming languages may be used.

For example, an entity may use a particular ETL tool (Abinitio) with significant investments. The entity may then decide to migrate from the particular ETL tool to another target ETL tool (Talend). The target ETL tool may include open source technologies. Migrating from the particular ETL tool to the target ETL tool requires converting underlying code which results in a significant effort and resource demand. The ETL tool migration process may include converting the code where the code may include multiple parts, such as extract code, transform code and load code.

An ETL workflow may include multiple steps. For example, a first step may involve reading source data, transforming the source data to target data and then writing the target data. A second step may include reading another set of data, transforming the data and then writing the data. Accordingly, the ETL tool is specific to the data structure that it is applied to. In other words, for the ETL process to execute, it needs to understand the structure of the data where the data structure may include number of attributes, type of attributes, etc.

For example, the data structure may define the data by attributes. In this example, an account file may have a particular data structure that includes a set of attributes. A first attribute may represent an account number; a second attribute may represent an account description; a third attribute may represent account type (e.g., text code value) and a fourth attribute may represent account balance. For example, an account number attribute may have a maximum length of 20 characters where the characters are only numbers. In this example, the ETL tool is aware that the account number attribute is represented by numbers with 20 or less characters. For an account code attribute, this attribute may be a two character code where the character code is a text string. Accordingly, the ETL tool is aware of the data structure prior to execution.

The ETL process may be applied to the specific data structure. In a similar manner, a target data structure may include a corresponding set of attributes. Data structure may include other formats as well.

Generally, converting the code from a first ETL tool to a second ETL tool requires substantial manual work because the first ETL tool and the second ETL tool have different languages on how source data structures and target data structures are defined, as well as the transformation between source and data structures. For example, the process may involve defining a particular data structure for the first ETL tool and another data structure for the second ETL tool.

An embodiment of the present invention is directed to an automated conversion of ETL code. The automated conversion is between source data structure and target data structure conversion from a first language to a second language. According to an exemplary embodiment, the automated conversion tool may perform data structure conversion from DML to XML as well as XML to DML. According to other embodiments of the present invention, the automated conversion tool may be applied to other languages.

Accordingly, an embodiment of the present invention is directed to an innovation framework that facilitates ETL code migration by converting a data structure definition from a first language to a second language.

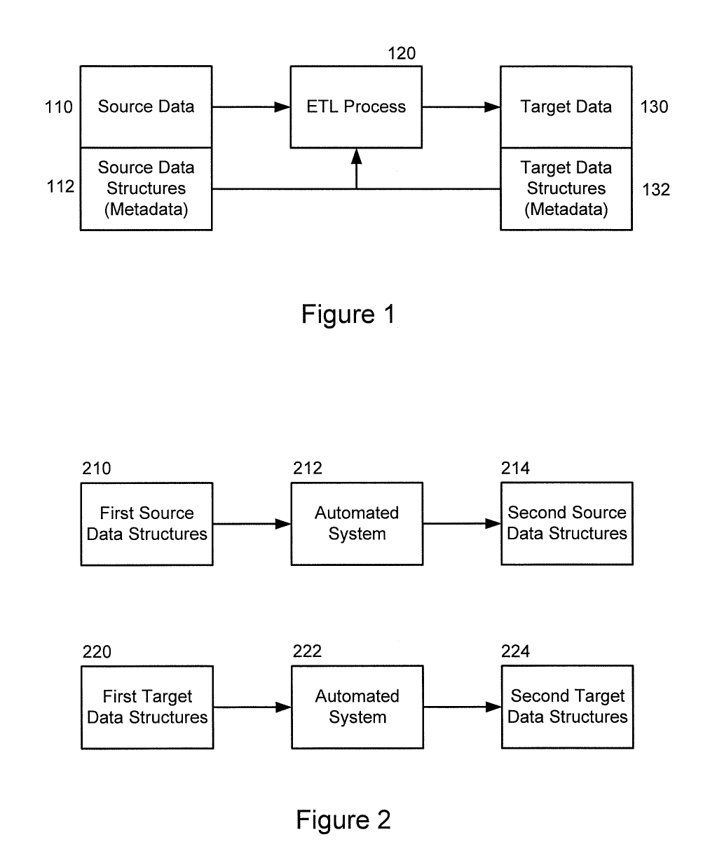

FIG. 1 is an exemplary diagram of a standard ETL workflow. As shown in FIG. 1, Source Data 110 may include source data structures, e.g., metadata, as represented by 112. The current ETL Process is represented by 120. Target Data 130 may include target data structures, e.g., metadata, as represented by 132. Current systems require a manual conversion process that involves extensive analysis of complex data structures, e.g., type of file, attributes, attribute type, etc.

FIG. 2 is an exemplary diagram of a ETL workflow, according to an embodiment of the present invention. As shown in FIG. 2, Source Data Structures 210 in a first language may be automatically migrated via Automated System 212 to Source Data Structures 214 in a second language. Likewise, Target Data Structures 220 in a first language may be automatically migrated via Automated System 222 to Target Data Structures 224 in a second language. For example, the first language may be DML and the second language may be XML, and vice versa. Other languages in various formats may be supported.

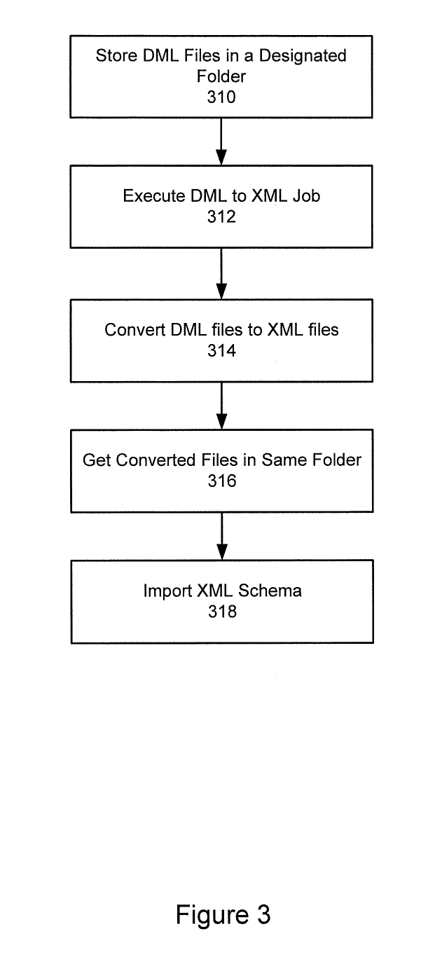

FIG. 3 is an exemplary flow diagram, according to an embodiment of the present invention. At step 310, DML files may be placed or stored in a designated folder. At step 312, a DML to XML job may be executed. This may involve iterating DML files one by one in a loop. At step 314, DML files may be converted to XML files. This may be performed by a parser that executes a DML to XML job. At step 316, converted files may be placed in the same folder. At step 318, XML schema may be imported. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed.

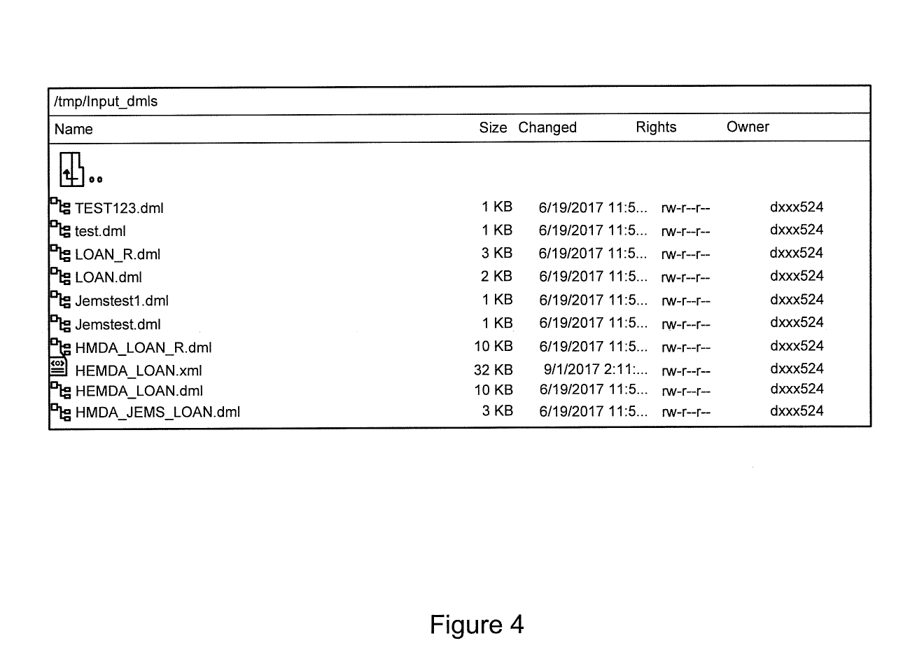

FIG. 4 is an exemplary screenshot, according to an embodiment of the present invention. In this example, the DML files are placed in folder: /tmp/Input_dmls.folder.

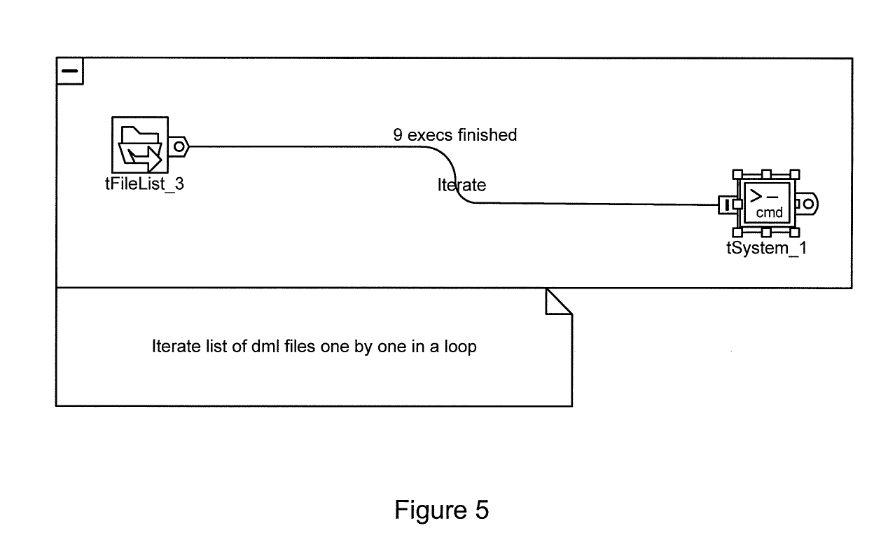

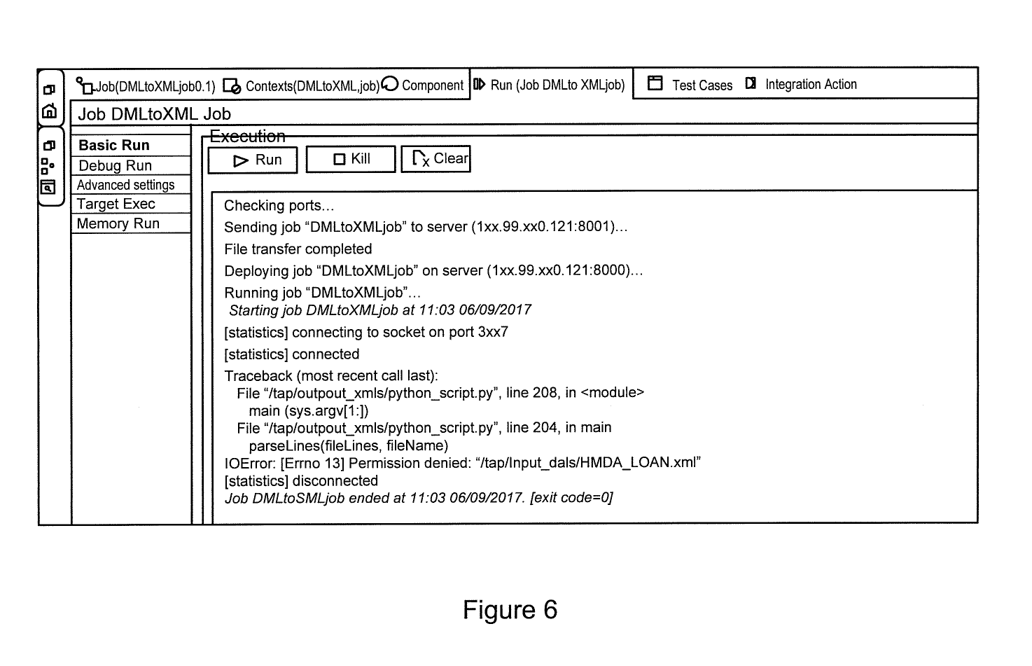

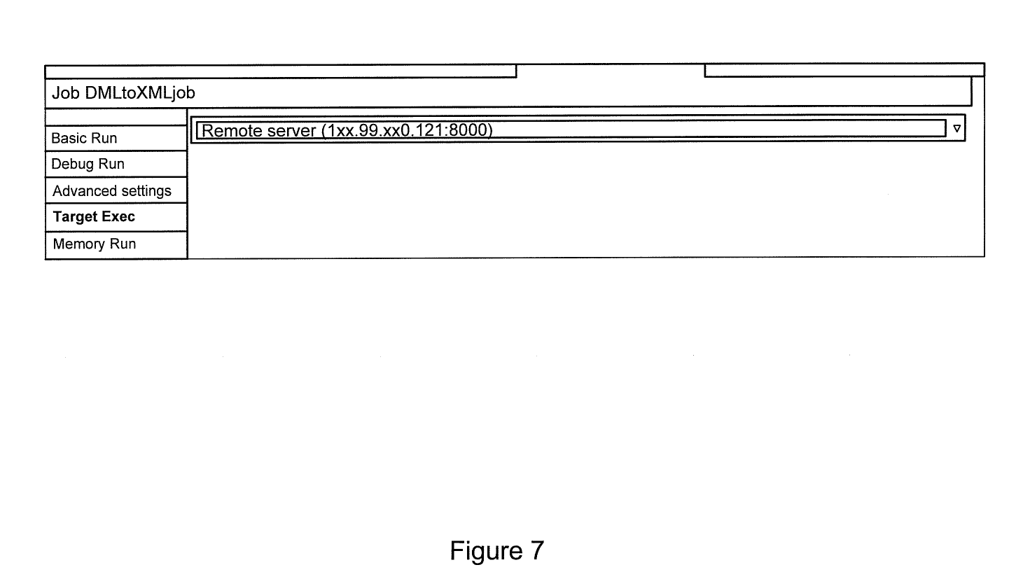

FIGS. 5, 6 and 7 are an exemplary screenshots, according to an embodiment of the present invention. In this example, DMLtoXML job is executed in Talend using Jobserver 37n14. The job may select Abnitio DML files one by one and convert into Talend XML files. As shown in FIG. 5, nine DML files have been selected and each selected file may be converted via code (e.g., Python code) into Talend Schema in XML (layout). FIG. 6 illustrates a log of the actions of FIG. 5 in an interface. In this example, the actions may include Python code execution and the interface may represent a Talend workspace GUI interface. FIG. 7 illustrates a server location of where the actions (e.g., Python code) are executed.

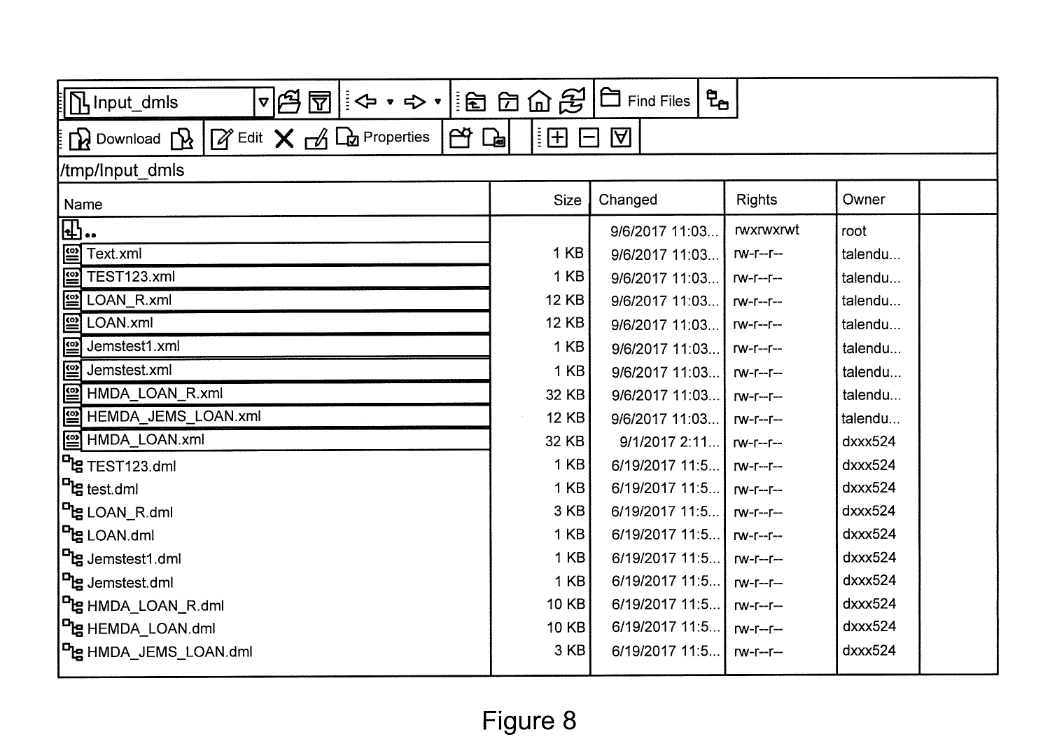

FIG. 8 is an exemplary screenshot, according to an embodiment of the present invention. In this example, converted output Talend Schema xml files are in the same folder /tmp/Input_dmls. FIG. 8 illustrates an output of the XML files after conversion from DML files.

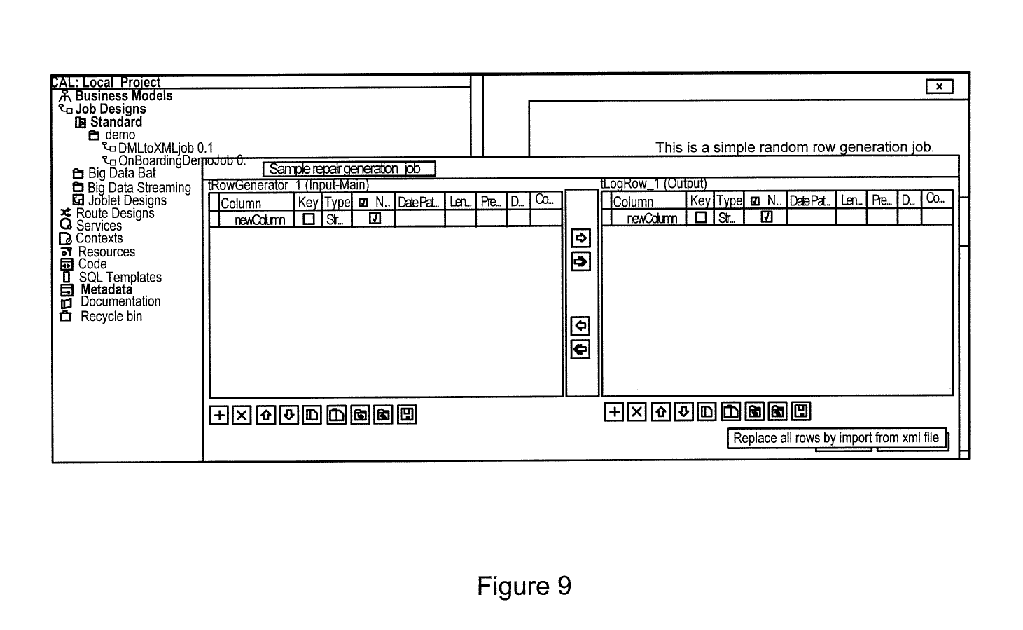

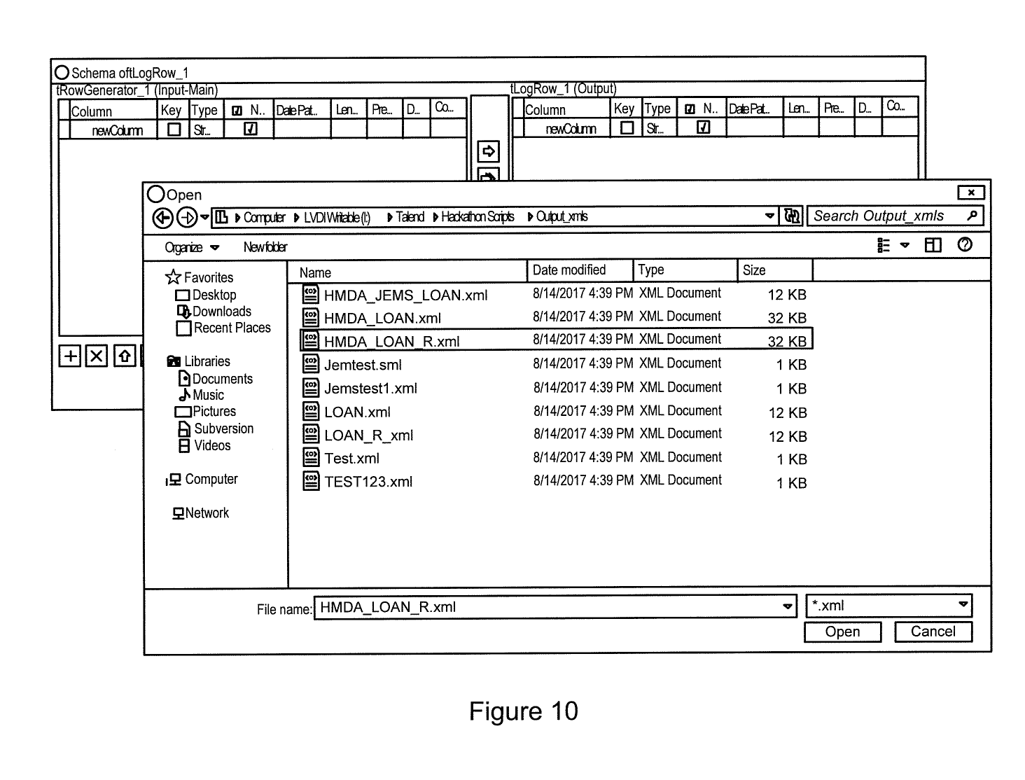

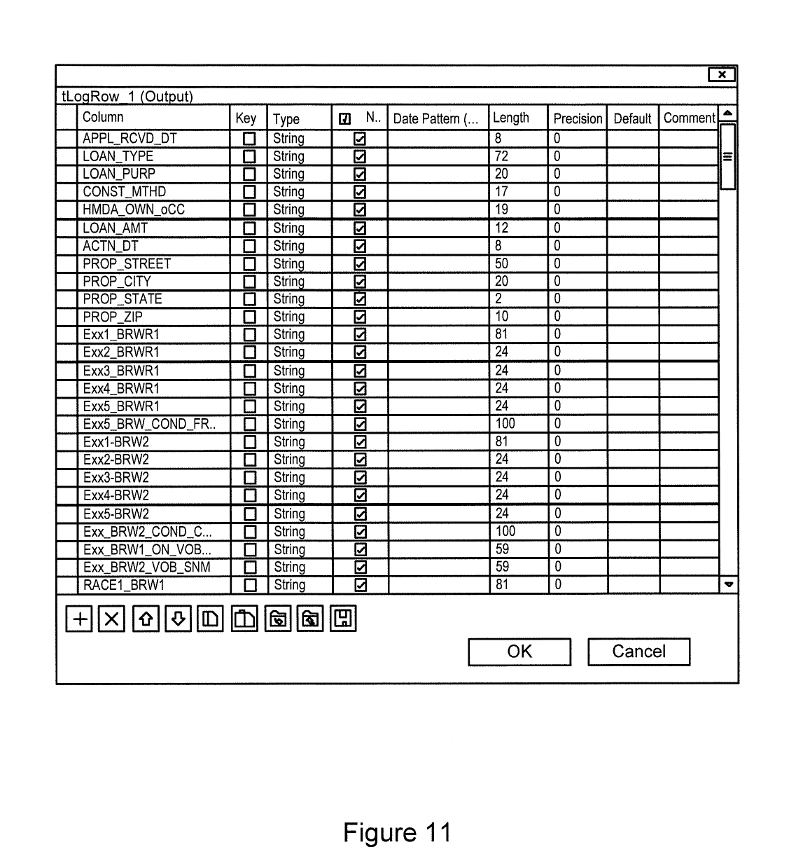

FIGS. 9, 10 and 11 are exemplary screenshots, according to an embodiment of the present invention. FIG. 9 illustrates a job in Talend that was created to execute the code, in this example Python code. FIG. 10 illustrates how to import converted XML into a Talend GUI Interface. In this example, FIGS. 9 and 10 illustrate importing one of the out Talend XML schema in any Talend schema. Talend schema XML may represent a XML file where the entire file layout is defined along with individual attribute property details. This XML file facilitates Talend to import the file layout directly from this file through import or export in a single interaction (e.g., click, etc.). FIG. 11 provides detailed attribute data including type, date pattern, length, etc.

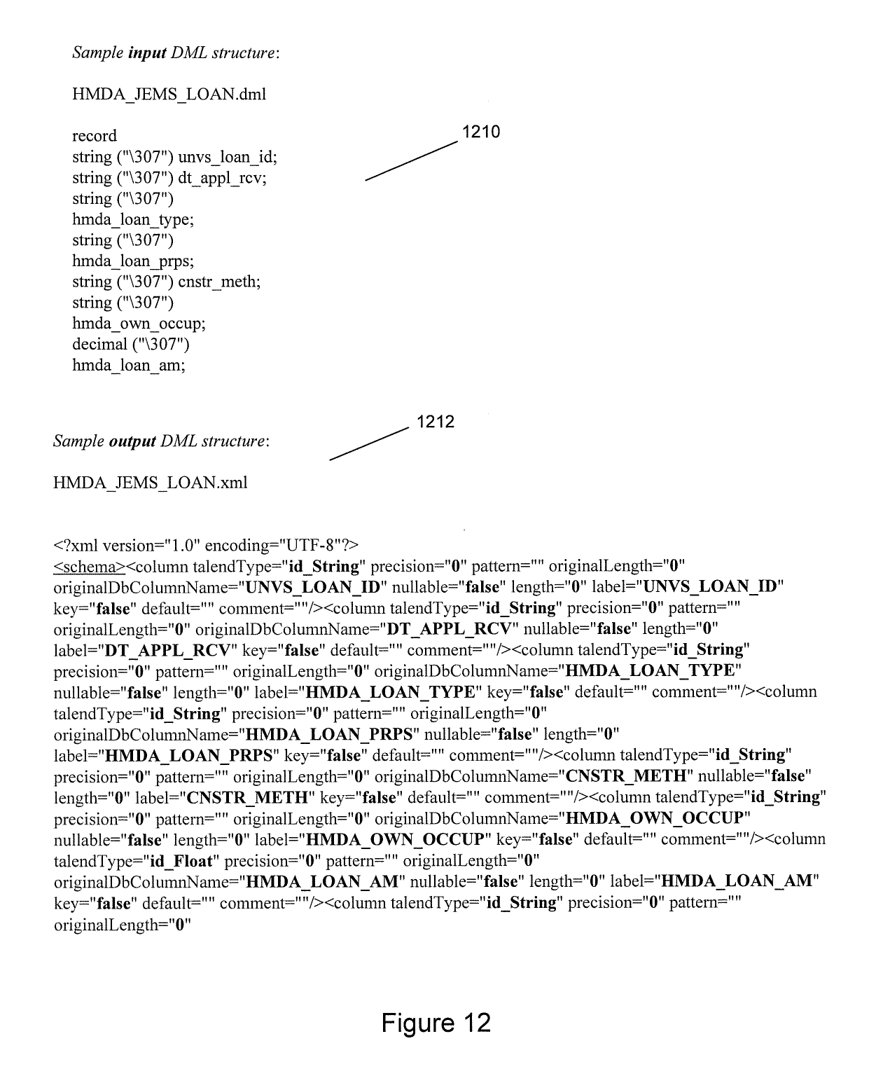

FIG. 12 illustrates exemplary detailed code samples, according to an embodiment of the present invention. FIG. 12 shows a sample input DML structure at 1210 and a sample output DML structure at 1212.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements extract, transform and load migration from a source data structure in a first language to a target data structure in a second language, the system comprising:
a memory component that stores data relating to the source data structure and the target data structure; and
a computer server coupled to the memory, the computer server comprising a programmed computer processor configured to perform the steps of:
storing source data structure files in a first programming language in a designated folder;
executing a conversion job from a source data structure to target data structure on a file by file basis;
automatically converting files from the source data structure to the target data structure in a second programming language;
storing the converted files in the same designated folder; and
importing a target data structure schema.

2. The system of claim 1, wherein the first programming language comprises DML.

3. The system of claim 1, wherein the second programming language comprises XML.

4. The system of claim 1, wherein the first programming language comprises DML and the second programming language comprises XML.

5. The system of claim 1, wherein the conversion job further comprises iterating a list of files one by one in a loop operation.

6. The system of claim 1, wherein the conversion job comprises a DML to XML job.

7. The system of claim 1, wherein the source data structure comprises a number of attributes and attribute characters.

8. The system of claim 1, wherein the source data structure is in Abinitio.

9. The system of claim 1, wherein the target data structure is in Talend.

10. The system of claim 1, wherein automatically converting files from a source data structure to a target data structure in a second programming language is performed by a parser.

11. A method that implements extract, transform and load migration from a source data structure in a first language to a target data structure in a second language, the method comprising the steps of:
storing source data structure files in a first programming language in a designated folder;
executing a conversion job from a source data structure to target data structure on a file by file basis;
automatically converting files from the source data structure to the target data structure in a second programming language;
storing the converted files in the same designated folder; and
importing a target data structure schema.

12. The method of claim 11, wherein the first programming language comprises DML.

13. The method of claim 11, wherein the second programming language comprises XML.

14. The method of claim 11, wherein the first programming language comprises DML and the second programming language comprises XML.

15. The method of claim 11, wherein the conversion job further comprises iterating a list of files one by one in a loop operation.

16. The method of claim 11, wherein the conversion job comprises a DML to XML job.

17. The method of claim 11, wherein the source data structure comprises a number of attributes and attribute characters.

18. The method of claim 11, wherein the source data structure is in Abinitio.

19. The method of claim 11, wherein the target data structure is in Talend.

20. The method of claim 11, wherein automatically converting files from a source data structure to a target data structure in a second programming language is performed by a parser.
